(19) United States
(12) Patent Application Publication
(10) Pub. No.: US 2020/0302544 A1
(43) Pub. Date: Sep. 24, 2020

(54) COMMUNITY DISCOUNT SYSTEMS AND METHODS FOR INSURANCE

(71) Applicants: Stephen N. Lekas, North Royalton, OH (US); Joseph T. Emison, Columbus, OH (US)

(72) Inventors: Stephen N. Lekas, North Royalton, OH (US); Joseph T. Emison, Columbus, OH (US)

(73) Assignee: Branch Financial, Inc., Columbus, OH (US)

(21) Appl. No.: 16/360,615

(22) Filed: Mar. 21, 2019

(51) Int. Cl. G06Q 40/08; G06Q 30/02

(52) U.S. Cl. CPC G06Q 40/08; G06Q 30/0214

(57) ABSTRACT

A community discount method for giving insurance discounts to customers of an insurance carrier that are part of communities. The method includes enabling a customer to purchase insurance from the carrier and to organize communities with other customers. A premium reduction is generated for organizing communities. The communities lower carrier expenses. The customer can receive a unique identifier, and other customers can purchase insurance from the carrier using the unique identifier to form a community. A discount can be generated for each customer in the community. The discount can be eliminated when customers cancel their policies. The discount can be a reduction of a factor used for premium calculation. The customer can identify other customers who may vouch for them; and send requests to the identified customers. A reduction can be generated when other customers respond to the vouch request and vouch for the customer.

### FIELD OF THE DISCLOSURE

The present disclosure relates to insurance systems, and more particularly to insurance systems that enable customers to benefit from forming communities in efforts to reduce acquisition costs and/or insurance fraud costs.

### BACKGROUND

Two of the biggest costs for insurance carriers are the costs of acquiring new customers, and the costs of investigating fraudulent claims and paying fraudulent claims that they cannot identify as fraudulent. These include both hard fraud (e.g., completely made-up claims), as well as soft fraud (e.g., inflating the value of a claim, like saying that the handbag was a genuine Louis Vuitton instead of a knock-off). Insurers must include these costs into their policy premiums. For most homeowners and auto insurance companies today, the cost of acquiring customers (as measured by spending on marketing as well as agent commissions) is the second-largest category of expense, behind paying claims. To the extent that an insurance carrier can reduce acquisition costs and/or fraud costs for a specific segment of customers, that insurance carrier can reduce the overall insurance premiums for that segment.

It would be desirable to provide a mechanism for customers of an insurance carrier to form their own communities (which in essence becomes their own segments), and subsequently reduce their cost of insurance by reducing the acquisition and/or fraud-related expenses of the insurance carrier for their policies.

### SUMMARY

A community discount method is disclosed for giving insurance discounts to customers of an insurance carrier that are part of one or more communities. The community discount method includes enabling a first customer to purchase a first insurance policy from the insurance carrier using a first electronic device; enabling the first customer to organize one or more communities with one or more other customers of the insurance carrier; and generating a reduction to the first premium as a result of the first customer organizing the one or more communities. The first insurance policy costs a first premium. Each of the one or more other customers is a new or existing customer of the insurance carrier, and each of the one or more communities lowers one or more expenses of the insurance carrier.

Enabling the first customer to organize one or more communities with one or more other customers of the insurance carrier can include sending a first unique identifier to the first customer, enabling a second customer to purchase a second insurance policy from the insurance carrier using a second electronic device and the first unique identifier; and forming a first community of the first and second customers. The second customer is one of the one or more other customers of the insurance carrier, and the second insurance policy costs a second premium. The first community is one of the one or more communities. The community discount method can also include generating a reduction to the second premium as a result of the first customer organizing the first community with the second customer of the insurance carrier. The community discount method can also include eliminating the reduction to the first premium when the second customer cancels the second insurance policy. The first unique identifier can be a universal resource locator uniquely identifying the first customer, or the first unique identifier can uniquely identify the first customer; and be configured to be electronically shared by the first customer with one or more potential customers, where the second customer is one of the one or more potential customers.

The community discount method can also include sending a second unique identifier to the second customer; enabling the second customer to organize one or more communities with the one or more other customers of the insurance carrier, enabling a third customer to purchase a third insurance policy from the insurance carrier using a third electronic device and the second unique identifier; and forming a second community of the second and third customers. The third insurance policy costs a third premium, and the second community is one of the one or more communities. The community discount method can also include generating a reduction to the third premium and a further reduction to the second premium as a result of the second customer organizing the second community with the third customer of the insurance carrier.

The community discount method can also include enabling a third customer to purchase a third insurance policy from the insurance carrier using a third electronic device and the first unique identifier; and forming a second community of the first and third customers. The third insurance policy costs a third premium, and the second community is one of the one or more communities. The community discount method can also include generating a reduction to the third premium and a further reduction to the first premium as a result of the first customer organizing the second community with the third customer of the insurance carrier.

The first premium can be a sum of prices for one or more coverages included in the first insurance policy, and each of the prices for the one or more coverages can be the product of a base coverage price and one or more relevant factors. Generating a reduction to the first premium can include reducing at least one of the one or more relevant factors used to calculate the first premium.

Enabling the first customer to organize one or more communities with one or more other customers of the insurance carrier can include enabling the first customer to identify one or more current insurance customers of the insurance carrier who may vouch for the first customer; and sending a vouch request to each of the one or more current insurance customers of the insurance carrier who may vouch for the first customer. Generating a reduction to the first premium can include, for each of the one or more current insurance customers of the insurance carrier that responds to the vouch request and vouches for the first customer, generating a reduction to the first premium.

Enabling the first customer to identify one or more current insurance customers of the insurance carrier who may vouch for the first customer can include receiving a plurality of contacts from the first electronic device; determining a list of one or more insured contacts, where each of the one or more insured contacts is a current insurance customer of the insurance carrier; sending the list of the one or more insured contacts to the first customer; and enabling the first customer to identify the one or more current insurance customers of the insurance carrier who may vouch for the first customer from the list of the one or more insured contacts to the first customer. The community discount method can also include requiring the first customer to provide identifying information to include in the vouch request. The identifying information can include a photograph of the first customer, or a photograph of the first customer with their driver's license, where the photograph is taken by the first electronic device.

The community discount method can also include when the first customer files a claim with the insurance carrier, reminding the first customer about the one or more current insurance customers that vouched for the first customer. Reminding the first customer about the one or more current insurance customers that vouched for the first customer can include sending a picture of at least one of the one or more current insurance customers that vouched for the first customer.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 illustrates how a community discount system can reduce acquisition expenses on an insurance policy;

FIG. 2 illustrates typical traditional insurance policy acquisition discount financing for four insurance policies;

FIG. 3 illustrates insurance policy acquisition discount financing for four insurance policies using the community discount system;

FIG. 4 illustrates a typical traditional rate order of calculation for an insurance policy;

FIG. 5 illustrates an exemplary rate order of calculation for an insurance policy using the community discount system;

FIG. 6 illustrates an example of functionality of the community discount system to reduce fraud expense;

FIG. 7 illustrates an example of a community discount system interaction when it comes time to file a claim after having received a fraud expense discount; and

FIG. 8 illustrates an exemplary environment for use of the community discount system.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

A community discount system provides certain customers of an insurance carrier who are within a community with the ability to reduce their cost of insurance by reducing the acquisition and fraud-related expenses that are applicable to their policies or related policies. The term “community” as used herein refers to any collection of people in which each person is connected to at least one other person. To the extent that an insurance carrier can reduce acquisition costs and/or fraud costs for a specific segment of customers, that insurance carrier can reduce the overall insurance premiums for that segment. The community discount system provides a mechanism for customers to form their own communities (which in essence become their own segment) and subsequently reduce their overall premiums.

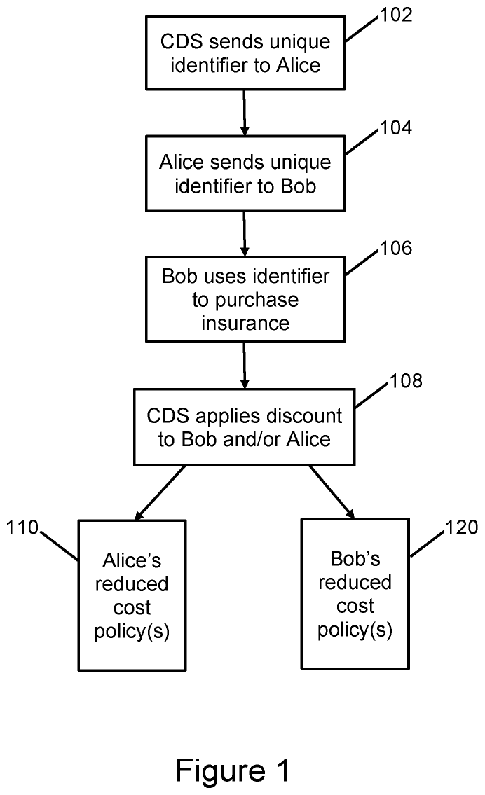

FIG. 1 illustrates how the community discount system can reduce new customer acquisition expenses on a policy. At block 102, the community discount system sends a unique identifier to a current customer (“Alice”). The unique identifier could be a universal resource locator (URL) link, an alphanumeric code, or other unique identifier for Alice. The unique identifier could be provided by the community discount system through its website, mobile app, email, text message or other communication method. At block 104, Alice invites a non-customer (“Bob”) to join Alice's community by purchasing insurance with Alice's insurance carrier using the unique identifier that is tied to Alice. Alice typically knows Bob and Bob is looking to get insurance. Alice can send the unique identifier to Bob via email, text message, social message, or other verbal, written or electronic communication. At block 106, Bob uses the unique identifier to purchase insurance from Alice's insurance carrier, and thus joins Alice's community. This saves the insurance carrier the acquisition expense associated with Bob. Since Bob came in through Alice, the insurance carrier will have spent less money overall on Bob than the average customer. Therefore, the insurance carrier can share that savings as a discount that Bob gets and also a discount that Alice gets. At block 108, the community discount system applies a discount to the policy or policies of Bob and Alice to reflect the reduced acquisition costs. This results in reduced cost insurance policy(s) for Alice 110 and reduced cost insurance policy(s) for Bob 120.

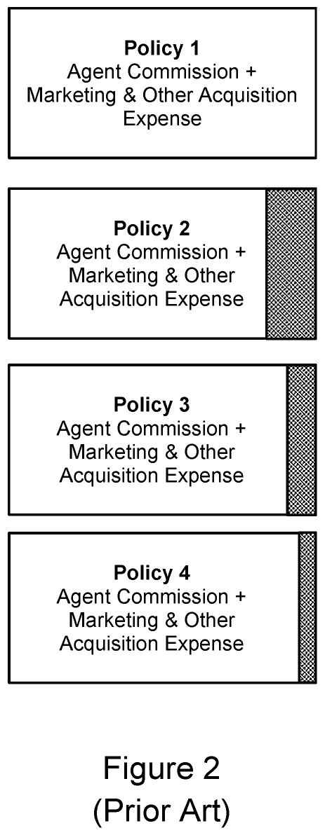

FIG. 2 illustrates typical traditional insurance policy acquisition discount financing for four insurance policies. Note that each of the four policies is separate and independent of the other policies, and each has acquisition costs associated with agent commissions plus marketing and other acquisition expenses. For the first policy, Policy 1, the insured pays the full amount of premiums because it did not qualify for any discounts. For the second policy, Policy 2, the insured receives a discount because the policy originated and was purchased online. For the third policy, Policy 3, the insured receives a discount because the policy originated and was purchased over the phone. For the fourth policy, Policy 4, the insured receives a discount because the policy was purchased through an agent referred by an affinity business partner, for example a national youth sports association. Of these discounts, the discount for purchasing online is usually the greatest, the discount for purchasing over the phone is usually less, and the discount for purchasing through an agent referred by an affinity business partner is usually the least.

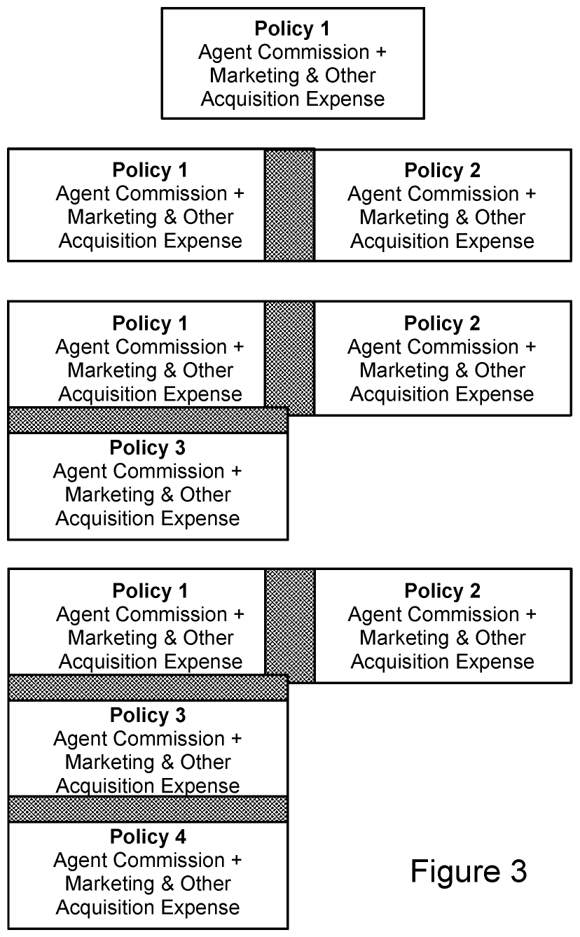

In contrast, FIG. 3 illustrates insurance policy acquisition discount financing for four insurance policies using the community discount system. Note that each of the four policies still have acquisition costs, but the policies are interconnected to one another. For the first policy, Policy 1, the insured originally pays the full amount of premiums because it did not qualify for any discounts. However, the insured for Policy 1 receives a first unique identifier.

When the second policy, Policy 2, is purchased through the community discount system using the first unique identifier as shown in FIG. 1, both Policy 1 and Policy 2 share the discount generated by the reduced acquisition cost in Policy 2. Policy 1 and Policy 2 are now interconnected to form a community, and the insured for Policy 2 receives a second unique identifier. One or both of the discounts generated can be removed if either of Policy 1 and Policy 2 is canceled.

When the third policy, Policy 3, is purchased through the community discount system using the first unique identifier as shown in FIG. 1, both Policy 1 and Policy 3 share the discount generated by the reduced acquisition cost in Policy 3. Thus, the insured of Policy 1 receives a further reduction in premiums. Policy 1 and Policy 3 are now interconnected to form a community, and the insured for Policy 3 receives a third unique identifier. The first unique identifier used to identify the insured of Policy 1 when Policy 2 was purchased and when Policy 3 was purchased could be the same identifier or different identifiers. One or both of the discounts generated can be removed if either of Policy 1 and Policy 3 is canceled.

When the fourth policy, Policy 4, is purchased through the community discount system using the third unique identifier as shown in FIG. 1, both Policy 3 and Policy 4 share the discount generated by the reduced acquisition cost in Policy 4. Policy 3 and Policy 4 are now interconnected to form a community, and the insured for Policy 4 receives a fourth unique identifier. One or both of the discounts generated can be removed if either of Policy 3 and Policy 4 is canceled.

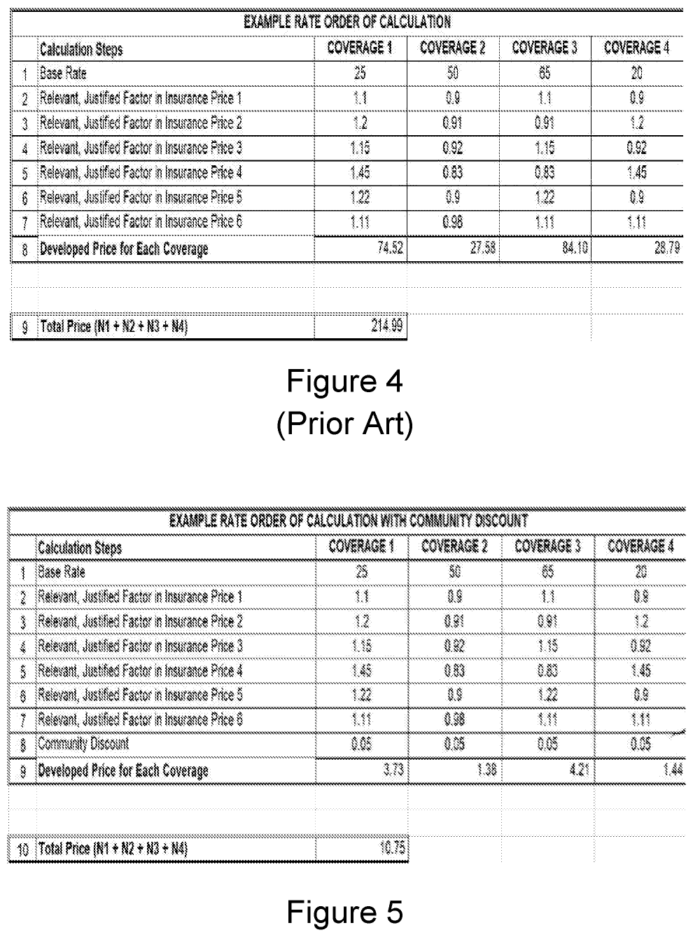

FIG. 4 illustrates a typical traditional rate order of calculation for an insurance policy. The policy can include multiple coverages, for example an automobile insurance policy can include collision, comprehensive, property damage, uninsured motorist and other coverages. Each coverage has a base rate and then there can be one or more relevant, justified factors that increase or decrease the coverage price, for example prior accidents or tickets can be an increasing factor (greater than 1.0), and automobile safety devices can be a decreasing factor (less than 1.0). The developed price for each coverage is the product of the base rate and all relevant, justified factors for that coverage. The total price of the insurance is then the sum of the prices for the included coverages.

FIG. 5 illustrates an exemplary rate order of calculation for an insurance policy using the community discount system. The policy, included coverages, base rates and relevant, justified factors are the same in FIG. 5 as in 4. However, FIG. 5 shows an additional factor for community discount. In this case the community discount factor is 95% (1.00-0.05). As an example, an insurance customer, Alice, can receive a 5% discount for each person that buys insurance using her unique identifier. When the nineteenth person buys insurance using Alice's unique identifier, then Alice receives a 19×5%=95% discount on her insurance premiums. In other examples, the community discount could be different for different coverages and may not apply to all coverages.

The community discount system approach of rewarding both Alice and Bob for reducing acquisition expense as shown in FIG. 1 through premium reduction is unique in insurance because of its implementation, through a discount structure in the rate filing. The community discount system can pass on reductions in acquisition expense as a discount in the rate order of calculation for insurance premium, not as a cash payment. As such, no one receives actual cash compensation in the form of a check, and a person is limited to a maximum amount of discount equal to their policy premium. The community discount system does not provide anything to non-customers. A person cannot receive a discount off their insurance with the community discount system until they are a customer of the insurance carrier. At that point, if they are referred to the insurance carrier by a community member (e.g., like Bob), then they receive a discount off their policy premium. And then they can refer other non-customers to receive an even-more-discounted premium. In all cases, nothing is being offered as an incentive to purchase insurance; every benefit is simply a reduction in rate for an existing policy.

Research in human behavior has revealed that people are less inclined to commit acts of dishonesty, like insurance fraud, when they understand how such dishonesty would hurt them and/or people they know. Additionally, behavioral research has shown that when people make a specific commitment to not be dishonest, when they are reminded of that commitment, they are less likely to be dishonest. To the extent that customers of an insurance carrier can set up a community of other customers who will hold each other accountable to be honest, that insurance carrier can reduce rates for the segment of people in the community.

The community discount system can include functionality that reduces fraud expense by enabling customers to create communities of customers that will hold each other accountable to be honest and not commit insurance fraud. This functionality can also be designed so that people who are inclined to commit fraud will not find it worthwhile.

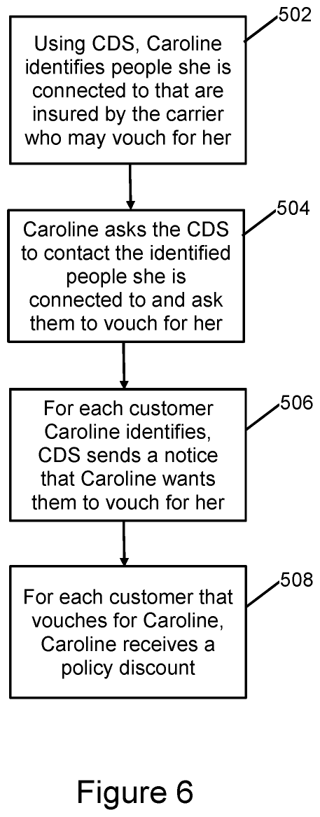

FIG. 6 illustrates an example of functionality of the community discount system to reduce fraud expense. The insurance carrier can offer a reduced premium due to the reduced fraud expense of people that have had others they are connected to vouch for them not to commit insurance fraud. In this example, both Caroline and Dennis are current customers of the insurance carrier.

At block 502, using the community discount system, Caroline finds people she is connected to that are insured by the insurance carrier. As an example, Caroline could access the community discount system through the insurance carrier website, mobile app or by telephone, and indicate her interest in having her premiums reduced by having another customer vouch for her not to commit insurance fraud. The insurance carrier may require Caroline to provide identifying information, for example a “selfie” (picture of herself) with her driver's license; to put her in the mindset that she is not anonymous and is connected with her “legal” self when asking for a fraud discount. Caroline can then be asked to share her contact list, for example by providing access to the insurance carrier on her smartphone, and the insurance carrier can determine which of her contacts is a customer of the insurance carrier who could vouch for her. If Caroline shares her contact list, the insurance carrier receives it electronically and returns a list of customers that are in her contact list. If Caroline does not share her contact list, she can manually enter the customers of the insurance carrier that she is connected to. Caroline next chooses or identifies (from the returned list and/or manually entered) customers of the insurance carrier that she believes will vouch for her.

At block 504, Caroline returns the list of customers of the insurance carrier that she chose or identified to the community discount system, and asks the community discount system to ask those customers to vouch for her.

At block 506, for each customer of the insurance carrier that Caroline has chosen or identified, the community discount system sends a notification that Caroline wishes them to vouch for her. For example, if one of the customer's Caroline identifies is Dennis, Dennis will receive a notification from the community discount system that Caroline wishes Dennis to vouch for Caroline. The notification can include a window or interface that asks Dennis whether he thinks Caroline will commit insurance fraud, and may remind him that insurance fraud hurts everyone in their insurance community. Dennis can choose to vouch or not to vouch for Caroline. The notification can include a photograph of Caroline.

At block 508, for each customer that returns the notification indicating that they will vouch for Caroline, Caroline receives a discounted policy premium. Each of the customers that returns the notification indicating that they will vouch for Caroline, is added to a fraud prevention community for Caroline. The discounted policy premium for Caroline is paid for by the anticipated reduced fraud expense of Caroline's policy/policies. The discount to the policy premium can be a community fraud factor that is reduced by a certain amount (for example, 1%, 3% or other amount) for each customer that returns the notification indicating that they will vouch for Caroline. The community fraud factor can apply to one or more coverages of the insurance policy with the discounted policy premium for Caroline. The amount of the fraud prevention discount can be reduced if people in the fraud prevention community for Caroline cancel their insurance policy(s) with or leave the insurance carrier.

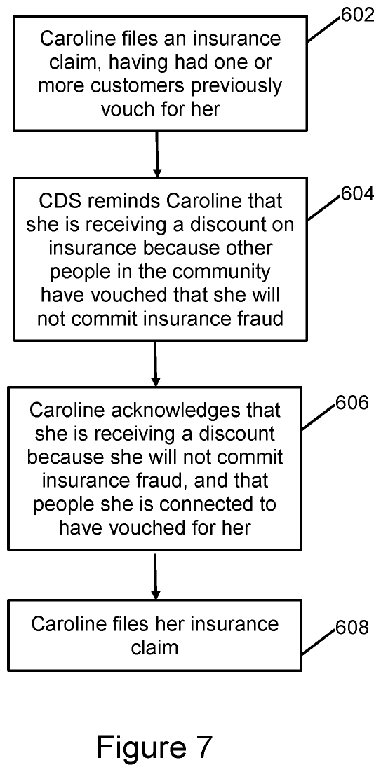

FIG. 7 illustrates an example of a community discount system interaction when it comes time for Caroline to file a claim. At block 602, Caroline files an insurance claim with the insurance carrier, having had one or more customers previously vouch for her through the community discount system that she is someone who would not commit insurance fraud. At block 604, the community discount system presents Caroline with a reminder that she is receiving a discount on insurance because she has had other people in the community vouch that she will not commit insurance fraud. The reminder can include pictures and/or names of those people who have vouched for her, and may also include an indication of how fraud would hurt them. At block 606, Caroline affirmatively acknowledges that she is receiving a discount because she will not commit insurance fraud, and that people she is connected to have personally vouched for her honesty. At block 608, Caroline files her claim.

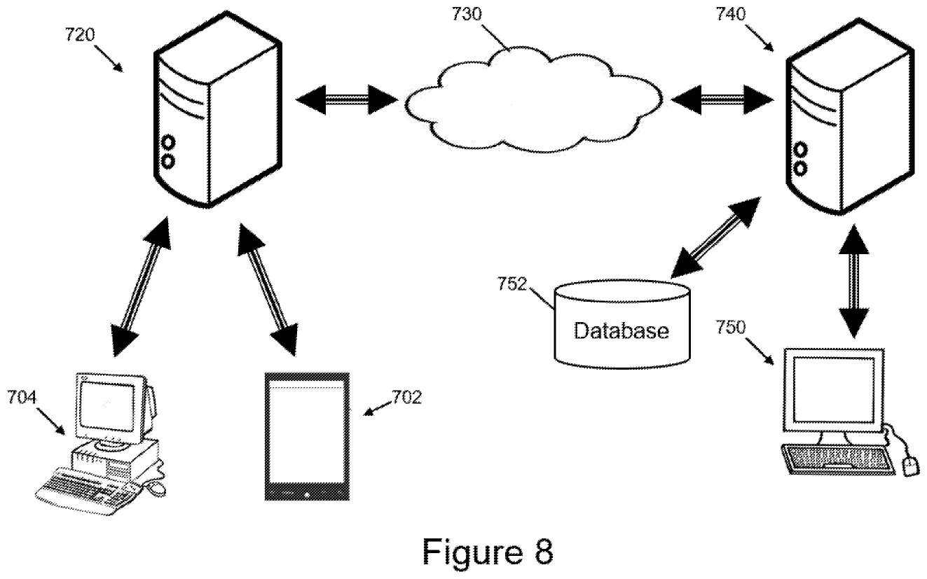

FIG. 8 illustrates an exemplary environment for use of the community discount system. A plurality of user electronic devices 702-704 (for example computers, smart phones or other electronic devices) can communicate with one or more server systems 720. Each of the user devices 702, 704 includes input, output, communication and storage mechanisms. For example, input mechanisms can include keyboard, mouse, touch screen, pointing device, etc.; output mechanisms can include display screen, printer, etc.; communication mechanisms can include wired networks, wireless networks and combinations thereof; and storage mechanisms can include local, networked, cloud-based and other storage systems. The server systems 720 can be phone system service providers, internet service providers or other types of service providers enabling access to networks and other electronic devices. The server system 720 can communicate with wide area networks 730, such as the internet. Other servers, such as an insurance carrier server 740 can also communicate with the wide area network 730 and with one or more local insurance carrier devices 750. The core of the community discount system can reside on the insurance carrier server 740 with local community discount applications and user interface screens on the devices 702, 704, 750. The insurance carrier devices 750 can be devices of an insurance carrier which can store and retrieve insurance and customer data from the insurance carrier server 740 and an insurance database 752. The devices 702, 704 and 750 can share data through the wide area network 730. User interface screens, text messages, email messages and/or other mechanisms can be used to share data, requests and notifications of the community discount system between the devices 702, 704 and 750. This is only one exemplary environment, and the community discount system can be used in numerous environments known by those of skill in the art.

While the disclosure has been illustrated and described in detail in the drawings and foregoing description, such illustration and description is to be considered as exemplary and not restrictive in character, it being understood that illustrative embodiment(s) have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

We claim:

1. A community discount method for giving insurance discounts to customers of an insurance carrier that are part of one or more communities; the community discount method comprising:
enabling a first customer to purchase a first insurance policy from the insurance carrier using a first electronic device; the first insurance policy costing a first premium;
enabling the first customer to organize one or more communities with one or more other customers of the insurance carrier, where each of the one or more other customers is a new or existing customer of the insurance carrier, and each of the one or more communities lowers one or more expenses of the insurance carrier; and
generating a reduction to the first premium as a result of the first customer organizing the one or more communities.

2. The community discount method of claim 1, wherein enabling the first customer to organize one or more communities with one or more other customers of the insurance carrier comprises:
sending a first unique identifier to the first customer;
enabling a second customer to purchase a second insurance policy from the insurance carrier using a second electronic device and the first unique identifier; the second customer being one of the one or more other customers of the insurance carrier, the second insurance policy costing a second premium;
forming a first community of the first and second customers, the first community being one of the one or more communities; and
wherein the community discount method further comprises:
generating a reduction to the second premium as a result of the first customer organizing the first community with the second customer of the insurance carrier.

3. The community discount method of claim 2, further comprising:
eliminating the reduction to the first premium when the second customer cancels the second insurance policy.

4. The community discount method of claim 2, wherein the first unique identifier is a universal resource locator uniquely identifying the first customer.

5. The community discount method of claim 2, wherein the first unique identifier uniquely identifies the first customer; and the first unique identifier is configured to be electronically shared by the first customer with one or more potential customers, the second customer being one of the one or more potential customers.

6. The community discount method of claim 5, further comprising:
sending a second unique identifier to the second customer;
enabling the second customer to organize one or more communities with the one or more other customers of the insurance carrier, where the second community lowers one or more expenses of the insurance carrier;
enabling a third customer to purchase a third insurance policy from the insurance carrier using a third electronic device and the second unique identifier; the third insurance policy costing a third premium;
forming a second community of the second and third customers, the second community being one of the one or more communities; and
wherein the community discount method further comprises:
generating a reduction to the third premium and a further reduction to the second premium as a result of the second customer organizing the second community with the third customer of the insurance carrier.

7. The community discount method of claim 5, further comprising:
enabling a third customer to purchase a third insurance policy from the insurance carrier using a third electronic device and the first unique identifier; the third insurance policy costing a third premium;
forming a second community of the first and third customers, the second community being one of the one or more communities; and
wherein the community discount method further comprises:
generating a reduction to the third premium and a further reduction to the first premium as a result of the first customer organizing the second community with the third customer of the insurance carrier.

8. The community discount method of claim 1, wherein the first premium is a sum of prices for one or more coverages included in the first insurance policy, and each of the prices for the one or more coverages is the product of a base coverage price and one or more relevant factors; and
wherein generating a reduction to the first premium comprises reducing at least one of the one or more relevant factors used to calculate the first premium.

9. The community discount method of claim 1, wherein enabling the first customer to organize one or more communities with one or more other customers of the insurance carrier comprises:
enabling the first customer to identify one or more current insurance customers of the insurance carrier who may vouch for the first customer; and
sending a vouch request to each of the one or more current insurance customers of the insurance carrier who may vouch for the first customer;
wherein generating a reduction to the first premium comprises, for each of the one or more current insurance customers of the insurance carrier that responds to the vouch request and vouches for the first customer, generating a reduction to the first premium.

10. The community discount method of claim 9, wherein enabling the first customer to identify one or more current insurance customers of the insurance carrier who may vouch for the first customer comprises:
receiving a plurality of contacts from the first electronic device;
determining a list of one or more insured contacts, wherein each of the one or more insured contacts is a current insurance customer of the insurance carrier;
sending the list of the one or more insured contacts to the first customer; and
enabling the first customer to identify the one or more current insurance customers of the insurance carrier who may vouch for the first customer from the list of the one or more insured contacts to the first customer.

11. The community discount method of claim 9, further comprising:
requiring the first customer to provide identifying information to include in the vouch request.

12. The community discount method of claim 11, wherein the identifying information comprises a photograph of the first customer.

13. The community discount method of claim 11, wherein the identifying information comprises a photograph of the first customer with their driver's license, wherein the photograph is taken by the first electronic device.

14. The community discount method of claim 9, further comprising:
when the first customer files a claim with the insurance carrier, reminding the first customer about the one or more current insurance customers that vouched for the first customer.

15. The community discount method of claim 14, wherein reminding the first customer about the one or more current insurance customers that vouched for the first customer comprises sending a picture of at least one of the one or more current insurance customers that vouched for the first customer.

16. The community discount method of claim 9, wherein enabling the first customer to organize one or more communities with one or more other customers of the insurance carrier further comprises:
sending a first unique identifier to the first customer; and
enabling a second customer to purchase a second insurance policy from the insurance carrier using a second electronic device and the first unique identifier; the second customer being one of the one or more other customers of the insurance carrier, the second insurance policy costing a second premium;
forming a first community of the first and second customers, the first community being one of the one or more communities; and
wherein the community discount method further comprises:
generating a reduction to the second premium as a result of the first customer organizing the first community with the second customer of the insurance carrier.

17. The community discount method of claim 16, wherein the first unique identifier is a universal resource locator uniquely identifying the first customer.

18. The community discount method of claim 17, wherein the first unique identifier uniquely identifies the first customer; and the first unique identifier is configured to be electronically shared by the first customer with one or more potential customers, the second customer being one of the one or more potential customers.

19. The community discount method of claim 16, further comprising:
sending a second unique identifier to the second customer;
enabling the second customer to organize one or more communities with the one or more other customers of the insurance carrier, where the second community lowers one or more expenses of the insurance carrier;
enabling a third customer to purchase a third insurance policy from the insurance carrier using a third electronic device and the second unique identifier; the third insurance policy costing a third premium;
forming a second community of the second and third customers, the second community being one of the one or more communities; and
wherein the community discount method further comprises:
generating a reduction to the third premium and a further reduction to the second premium as a result of the second customer organizing the second community with the third customer of the insurance carrier.

20. The community discount method of claim 16, further comprising:
enabling a third customer to purchase a third insurance policy from the insurance carrier using a third electronic device and the first unique identifier; the third insurance policy costing a third premium;
forming a second community of the first and third customers, the second community being one of the one or more communities; and
wherein the community discount method further comprises:
generating a reduction to the third premium and a further reduction to the first premium as a result of the first customer organizing the second community with the third customer of the insurance carrier.
